(19) United States
(12) Patent Application Publication
(10) Pub. No.: US 2025/0296149 A1
(43) Pub. Date: Sep. 25, 2025

(54) CLEANING DEVICE AND CLEANING METHOD

(71) Applicant: MITSUBISHI HEAVY INDUSTRIES, LTD., Tokyo (JP)

(72) Inventors: Takahiro TACHIBANA, Tokyo (JP); Hiroki MORI, Tokyo (JP); Akihiro TANAKA, Tokyo (JP); Sayaka MARUTA, Tokyo (JP)

(73) Assignee: MITSUBISHI HEAVY INDUSTRIES, LTD., Tokyo (JP)

(21) Appl. No.: 18/863,570

(22) PCT Filed: Feb. 17, 2023
(86) PCT No.: PCT/JP2023/005767

§ 371 Date: Nov. 6, 2024

(30) Foreign Application Priority Data
May 12, 2022 (JP) 2022-078873

(51) Int. Cl. B22F 10/68; B08B 3/08; B08B 3/12; B33Y 40/20

(52) U.S. Cl. CPC B22F 10/68; B08B 3/08; B08B 3/12; B33Y 40/20

(57) ABSTRACT

The purpose of the present invention is to optimally remove unnecessary powder from a metal lamination-shaped article. This cleaning device (10) is for cleaning a metal lamination-shaped article (20) formed by laminating layers which are each obtained by layering a metallic powder material and irradiating a portion thereof with a laser beam to melt-bond or sinter the same. The cleaning device (10) comprises: an inner container (12) that is filled with a mixed solvent M being a liquid obtained by mixing a plurality of organic solvents and that accommodates the metal lamination-shaped article (20) in a state of being immersed in the mixed solvent (M); and an ultrasound-emitting device (13) which transmits ultrasounds (U) to the metal lamination-shaped article (20) being accommodated in the inner container (12). The plurality of organic solvents include: a first organic solvent that has a higher vapor pressure than the other organic solvents; and a second organic solvent that has higher acoustic impedance than the other organic solvents.

### TECHNICAL FIELD

The present disclosure relates to a cleaning device and a cleaning method.

### BACKGROUND ART

Various methods for manufacturing a metal three-dimensional printed article having a complicated shape have been developed. As an example, a powder bed fusion method is known (for example, PTL 1). The powder bed fusion method is a manufacturing method of a three-dimensional printed article by forming thin layers by evenly laying out a metal powder material, manufacturing a metal lamination-printed article by irradiating a region to be cured with laser light to sinter or fuse a powder material among the thin layers, cleaning the manufactured metal lamination-printed article, and removing an unnecessary powder material (an uncured powder material or the like) from the metal lamination-printed article. PTL 1 discloses that a powder adhering to a component is peeled off by emitting an ultrasonic wave to the component soaked in cleaning liquid.

### CITATION LIST

### Patent Literature

[PTL 1] Japanese Patent No. 6871908

### SUMMARY OF INVENTION cl Technical Problem

In addition to the method described in PTL 1, as a removing method of a metal material from the metal lamination-printed article, removal by an input using a tool such as a spatula or an air blow or removal by a solvent or an abrasive grain for removing a powder is considered. In a case where a three-dimensional printed article having a complicated shape is manufactured by a powder bed fusion method, it is necessary to remove a metal powder from a narrow portion. However, it is difficult to insert the tool into the narrow portion. Therefore, in a case where the three-dimensional printed article having a complicated shape is manufactured by the powder bed fusion method or in similar cases, there is a possibility that the sufficiently unnecessary metal powder in a method using the tool cannot be sufficiently removed. In addition, in a case where the metal powder is removed from a bottomed flow path-shaped portion in which one end is closed, it is difficult to load pressure to flow the solvent or the abrasive grain into the portion. Therefore, in such a case, in a method using the solvent or the abrasive grain, there is a possibility that the sufficiently unnecessary metal powder cannot be sufficiently removed.

In addition, in a case where the three-dimensional printed article is manufactured by using a metal having a low melting point and a low laser absorption efficiency such as copper or a copper alloy, the laser light is also scattered to a region other than the irradiation region. In such a case, the entire region is heated by the scattered light, a temperature rises, and as a result, there is a possibility that sintering is performed to bond powders to each other. In a case where the powders are bonded to each other, it is difficult to remove an unnecessary powder from the metal lamination-printed article. In PTL 1, a cleaning liquid in which the metal lamination-printed article is immersed is not studied. Therefore, in the method of PTL 1, there is a possibility that the sintered unnecessary metal powder cannot be sufficiently removed.

The present disclosure has been made in view of such a circumstance, and an object of the present disclosure is to provide a cleaning device and a cleaning method that can preferably remove the unnecessary powder from the metal lamination-printed article.

### Solution to Problem

In order to solve the above-described problem, a cleaning device and a cleaning method of the present disclosure adopt the following means.

According to an aspect of the present disclosure, there is provided a cleaning device that cleans a metal lamination-printed article printed by laminating a layer that is a layer in which a metal powder material is laid out and a part of the layer is irradiated with laser light to be fused or sintered, the cleaning device including: a housing unit that is filled with a mixed solvent inside, which is a liquid in which a plurality of organic solvents are mixed and houses the metal lamination-printed article in a state of being immersed in the mixed solvent; and an ultrasonic wave transmitting unit that transmits an ultrasonic wave to the metal lamination-printed article housed in the housing unit, in which the plurality of organic solvents include a first organic solvent having higher vapor pressure than vapor pressure of other organic solvents and a second organic solvent having higher acoustic impedance than acoustic impedance of the other organic solvent.

In addition, according to an aspect of the present disclosure, there is provided a cleaning method for cleaning a metal lamination-printed article printed by laminating a layer that is a layer in which a metal powder material is laid out and a part of the layer is irradiated with laser light to be fused or sintered, the cleaning method including: a housing step of housing the metal lamination-printed article in a state of being immersed in a mixed solvent in a housing unit filled with the mixed solvent inside, which is a liquid in which a plurality of organic solvents are mixed; and an ultrasonic wave transmitting step of transmitting an ultrasonic wave from an ultrasonic wave transmitting unit to the metal lamination-printed article housed in the housing unit, in which the plurality of organic solvents include a first organic solvent having higher vapor pressure than vapor pressure of other organic solvents and a second organic solvent having higher acoustic impedance than acoustic impedance of the other organic solvent.

### Advantageous Effects of Invention

According to the present disclosure, an unnecessary powder can be preferably removed from a metal lamination-printed article.

### BRIEF DESCRIPTION OF DRAWINGS

FIG. 1 is a schematic longitudinal sectional view of a cleaning device according to an embodiment of the present disclosure.

FIG. 2 is a flowchart showing a cleaning method according to the embodiment of the present disclosure.

FIG. 3 is a diagram showing a principle of removing a powder with cavitation.

### DESCRIPTION OF EMBODIMENTS

Hereinafter, an embodiment of a cleaning device and a cleaning method according to the present disclosure will be described with reference to the drawings.

A cleaning device 10 according to the present embodiment is used when a metal three-dimensional printed article is manufactured. A metal used as a material is not particularly limited. For example, the metal may be a metal (for example, copper or a copper alloy) having a low melting point and a low laser absorption rate. In addition, the metal may be a metal (for example, a nickel alloy) having a high melting point and a high laser absorption rate.

When the three-dimensional printed article is manufactured, first, a metal lamination-printed article 20 is printed by laminating a layer that is a layer in which a metal powder material is laid out and a part of the layer is irradiated with laser light to be fused or sintered. Then, the three-dimensional printed article is manufactured by removing an unnecessary powder material from the metal lamination-printed article 20. The cleaning device 10 according to the present embodiment is used when the unnecessary powder material is removed from the metal lamination-printed article 20.

In the metal lamination-printed article 20 of the present embodiment, a plurality of bottom-shaped holes 21 are formed. The holes 21 are formed to be recessed from a surface of the metal lamination-printed article 20.

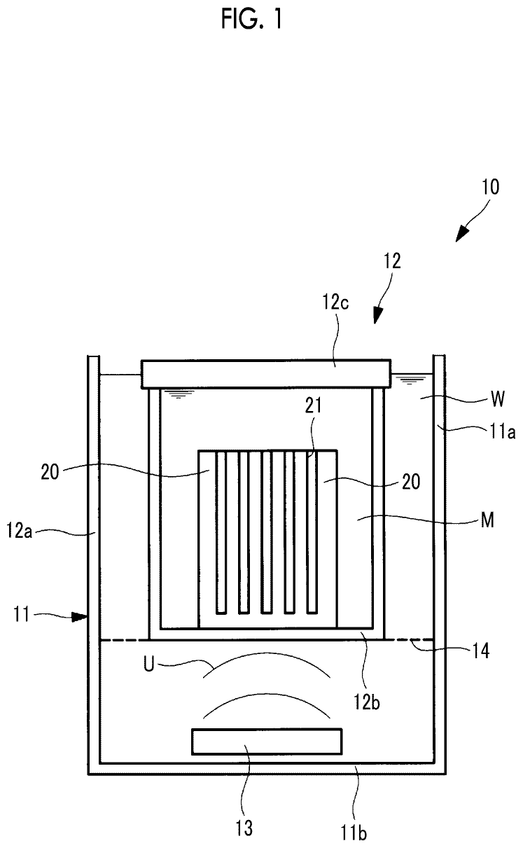

As shown in FIG. 1, the cleaning device 10 includes an outer container 11 forming an outer shell, an inner container (a housing unit) 12 provided in the outer container 11, and an ultrasonic wave generating device (an ultrasonic wave transmitting unit) 13 provided below the inner container 12, which is inside the outer container 11.

The outer container 11 includes a cylindrical outer container main body portion 11a and an outer container bottom surface portion 11b that closes a lower end of the outer container main body portion 11a. An upper end of the outer container main body portion 11a is open. A liquid (in the present embodiment, water W as an example) is filled inside the outer container 11. A substance filled inside the outer container 11 may be any substance that is difficult to attenuate an ultrasonic wave, and is not limited to water.

A water surface of the water W filled inside the outer container 11 is higher than an upper end of an inner container main body portion 12a to be described later.

An internal space of the outer container 11 is divided in the up-down direction by a porous plate 14 extending in the horizontal direction. An outer peripheral portion of the porous plate 14 is fixed to an inner peripheral surface of the outer container 11. The porous plate 14 is formed with a plurality of pores penetrating in the up-down direction. Material quality of the porous plate 14 is not particularly limited. However, it is preferable that the porous plate 14 is formed of a material (for example, stainless steel) that is unlikely to significantly attenuate an ultrasonic wave U from the ultrasonic wave generating device 13.

The inner container 12 integrally includes the cylindrical inner container main body portion 12a and an inner container bottom surface portion 12b that closes a lower end of the inner container main body portion 12a. The upper end of the inner container main body portion 12a is closed from above by a lid portion 12c. The inner container 12 is placed on an upper surface of the porous plate 14. The inner container 12 is immersed in the water W approximately entirely filled in the outer container 11. Specifically, the inner container 12 is immersed in the water W entirely filled in the outer container 11 except for a part of an upper side of the lid portion 12c.

A liquid-shaped mixed solvent M in which a plurality of (in the present embodiment, as an example, three types) organic solvents are mixed is filled inside the inner container 12. In addition, the metal lamination-printed article 20 is housed inside the inner container 12. Therefore, the metal lamination-printed article 20 in a state of being immersed in the mixed solvent M is housed inside the inner container 12. Details of the mixed solvent M will be described later.

A supply pipe (not shown) that supplies the mixed solvent M inside the inner container 12 is connected to the inner container 12. The supply pipe may be, for example, provided to penetrate the lid portion 12c.

Material quality of the inner container 12 is not particularly limited. However, it is preferable that the inner container 12 is formed of a material (for example, stainless steel) that is unlikely to significantly attenuate the ultrasonic wave U from the ultrasonic wave generating device 13.

Next, the mixed solvent M will be described.

In the mixed solvent M, three types of organic solvents of a first organic solvent, a second organic solvent, and a third organic solvent are mixed. Here, as will be described later, the three types of organic solvents are mixed with each other to improve occurrence frequency and an occurrence intensity of cavitation. Both characteristics of vapor pressure and acoustic impedance of each organic solvent included in the mixed solvent M satisfy a required condition, so that the occurrence frequency and the occurrence intensity of cavitation are improved.

The first organic solvent has higher vapor pressure than vapor pressure of other organic solvents (in the present embodiment, the second organic solvent and the third organic solvent) included in the mixed solvent M. As the first organic solvent, for example, an organic solvent is preferable, which has vapor pressure equal to or higher than 2.5 kPa at room temperature. The first organic solvent may be, for example, acetone. Ease of evaporation of the solvent (a height of vapor pressure) significantly affects the occurrence frequency of cavitation.

Acoustic impedance (a sound speed×a density) of the second organic solvent is higher than acoustic impedance of the other organic solvent (in the present embodiment, the first organic solvent and the third organic solvent) included in the mixed solvent M. The second organic solvent is, for example, preferably an organic solvent having acoustic impedance equal to or higher than 700 kPa·s/m³ at room temperature. The second organic solvent may be, for example, methyl ethyl ketone, isopropyl alcohol, or ethanol. The acoustic impedance significantly affects the occurrence intensity of cavitation.

The third organic solvent has lower viscosity than viscosity of the other organic solvent (in the present embodiment, the first organic solvent and the second organic solvent) included in the mixed solvent M. As the third organic solvent, for example, an organic solvent having viscosity equal to or lower than 1.0 mPas at room temperature is preferable. As the third organic solvent, for example, n-hexane, n-pentane, or an ether may be used. The viscosity significantly affects the occurrence intensity of cavitation.

The mixing ratio of each organic solvent may be determined in consideration of both intensity and the occurrence frequency of cavitation according to the powder material to be removed.

The ultrasonic wave generating device 13 is disposed below the porous plate 14. The ultrasonic wave generating device 13 is provided on an upper surface of the outer container bottom surface portion 11b. The ultrasonic wave generating device 13 transmits the ultrasonic wave U upward. The ultrasonic wave generating device 13 transmits the ultrasonic wave U to the metal lamination-printed article 20 via the water W inside the outer container 11 or the mixed solvent M inside the inner container 12.

A frequency of the ultrasonic wave U transmitted by the ultrasonic wave generating device 13 is set to a frequency band of several tens to several hundreds of kHz at which cavitation occurs. In this range, the smaller the frequency of the ultrasonic wave U, the more difficult it is to reduce amplitude, and the more likely cavitation is to occur as a whole. Therefore, by setting the frequency of the ultrasonic wave U in this range, cavitation can preferably occur and the powder can be removed.

In addition, the cleaning device 10 includes a controller that controls various devices (for example, the ultrasonic wave generating device or the like).

The controller includes, for example, a central processing unit (CPU, processor), a main memory, a secondary storage (memory), or the like. Further, the controller may include a communication unit for transmitting and receiving information to and from another device.

The main memory is configured with, for example, a writable memory such as a cache memory or a random access memory (RAM), and is used as a work region performing reading of an execution program of the CPU, writing of process data by the execution program, or the like.

The secondary storage is a non-transitory computer readable storage medium. storage is, for example, a magnetic disk, a magneto-optical disk, a CD-ROM, a DVD-ROM, a semiconductor memory, or the like.

As an example, a series of processes for implementing various functions are stored in the secondary storage in a program form, and the CPU reads the program into the main memory to execute a processing and operating process of information, so that various functions are implemented. In the program, a form in which the program is installed in advance in the secondary storage, a form in which the program is provided in a state where the program is stored in a computer-readable storage medium, a form in which t the program is delivered via wired or wireless communication means, or the like may be applied. The computer-readable storage medium is a magnetic disk, a magneto-optical disk, a CD-ROM, a DVD-ROM, a semiconductor memory, or the like.

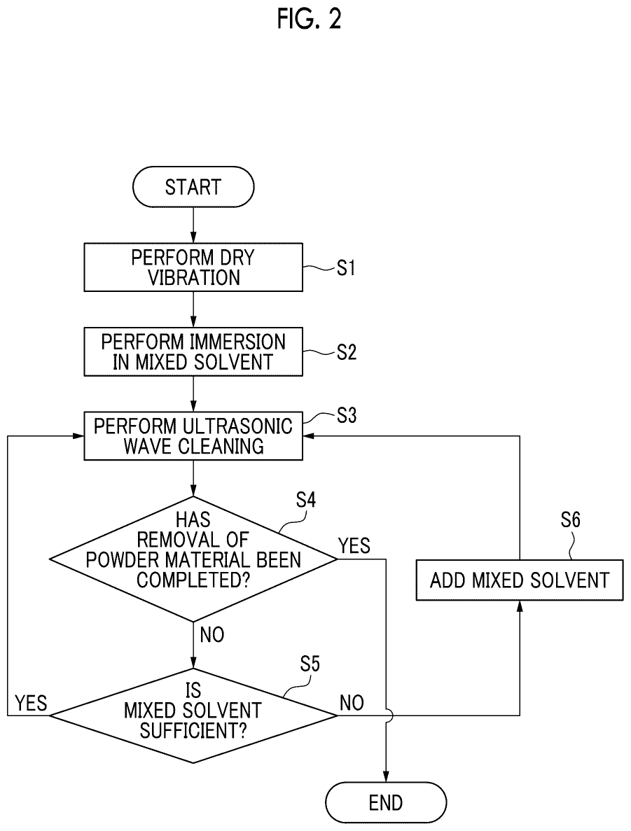

Next, a cleaning method of the metal lamination-printed article 20 will be described with reference to a flowchart of FIG. 2.

In the cleaning method according to the present embodiment, as shown in FIG. 1, a dry vibrating device (not shown) initially vibrates the metal lamination-printed article 20 to remove the unnecessary powder material from the metal lamination-printed article 20 (step S1). In the dry vibrating device, the metal lamination-printed article 20 is vibrated without being immersed in a liquid or the like. In this step, as described above, it is difficult to remove the unnecessary powder material in a sintered state. However, by providing a dry vibrating step before ultrasonic wave cleaning to be described later, the mixed solvent M can be easily infiltrated when the ultrasonic wave cleaning is performed.

Next, the metal lamination-printed article 20 is housed at a predetermined position of the inner container 12 and is immersed in the mixed solvent M (housing step, step S2). Next, the ultrasonic wave U is transmitted from the ultrasonic wave generating device 13 (ultrasonic wave transmitting step), and the ultrasonic wave cleaning is performed in the metal lamination-printed article 20 (step S3). Cavitation occurs in the mixed solvent M by transmitting the ultrasonic wave U from the ultrasonic wave generating device 13. Since cavitation occurs, the sintered powder material is crushed. Therefore, the unnecessary powder material can be removed from the metal lamination-printed article 20. Details of a principle of removing the powder by cavitation will be described later.

After the ultrasonic wave cleaning is ended, it is determined whether or not the unnecessary powder material can be sufficiently removed from the metal lamination-printed article 20 (step S4). In a case where it is determined that the removal of the unnecessary powder material has been completed, the cleaning of the metal lamination-printed article 20 is ended.

In step S4, in a case where it is determined that the removal of the unnecessary powder material has not been completed, next, it is determined whether or not an amount of the mixed solvent M in the inner container 12 is sufficient (step S5). Whether or not the amount of the mixed solvent M is sufficient may be determined, for example, depending on whether or not a part of the metal lamination-printed article 20 is exposed from the mixed solvent M. In this case, in a case where even a part of the metal lamination-printed article 20 is exposed from the mixed solvent M, it is determined that the amount of the mixed solvent M is not sufficient.

In step S5, in a case where it is determined that the amount of the mixed solvent M in the inner container 12 is sufficient, the process returns to step S3, and the ultrasonic wave cleaning is performed again. On the other hand, in step S5, in a case where it is determined that the amount of the mixed solvent M in the inner container 12 is not sufficient, the mixed solvent M is added in the inner container 12 via the supply pipe (not shown) (step S6). Then, the process returns to step S3, and the ultrasonic wave cleaning is performed again.

In the present embodiment, the cleaning of the metal lamination-printed article 20 is performed in this way. In the metal lamination-printed article 20 on which the cleaning method of the present embodiment is performed, fine cracks (cracks having a depth of about 10μ and a width of about 5μ) peculiar to ultrasonic waves are generated on the surface. Since the crack is very small, product quality of the manufactured three-dimensional printed article is not affected.

In step S4, in a case where it is determined that the unnecessary powder material can be sufficiently removed from the metal lamination-printed article 20, the metal lamination-printed article 20 may be taken out from the cleaning device 10 and the metal lamination-printed article 20 may be vibrated again by the dry vibrating device (not shown). Since the sintered powder material is crushed in step S4, the crushed powder material can be removed from the metal lamination-printed article 20 by vibrating the metal lamination-printed article 20 with the dry vibrating device after step S4.

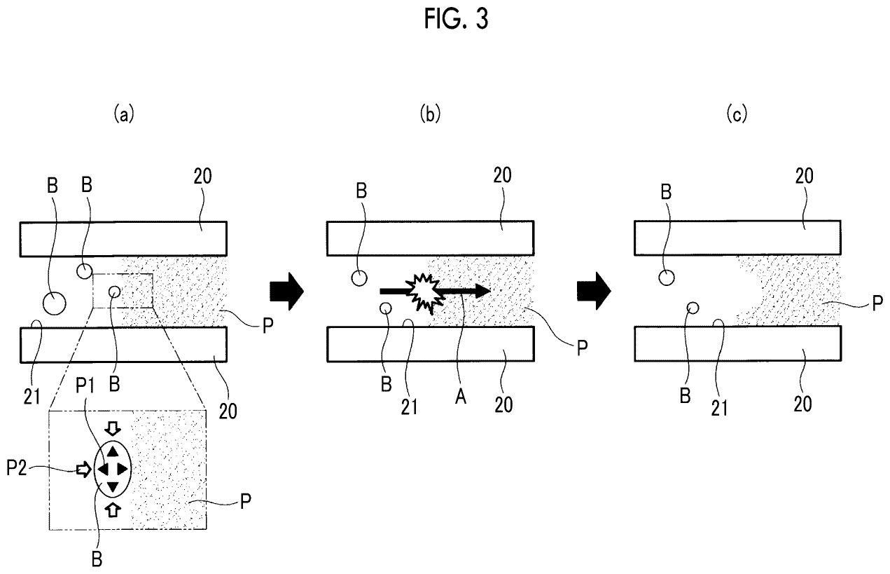

Next, the principle of removing the powder by cavitation will be described with reference to FIG. 3.

In FIG. 3, a reference numeral P indicates powder materials remaining in the hole 21 of the metal lamination-printed article 20 in a state where the powder materials are sintered to each other. In addition, a reference numeral B indicates bubbles generated in the mixed solvent M by the ultrasonic wave U. In addition, in (a), a region surrounded by a two-dot chain line is shown in an enlarged manner.

As shown in (a) of FIG. 3, when gas molecules of the mixed solvent M are irradiated with the ultrasonic wave U (refer to FIG. 1), gas pressure enters to be equal to or lower than vapor pressure by means of positive and negative pressure cycle, so that the gas molecules are evaporated, bubbles B are generated, and the bubbles B are foamed. That is, as shown in (a) of FIG. 3, pressure unevenness occurs between internal pressure P1 and external pressure P2 of the bubble B.

When the bubbles B are foamed, as shown in (b) of FIG. 3, a flow of the high-pressure and high-speed of the mixed solvent M occurs, and the flow collides with a powder material P in the sintered state (refer to an arrow

A). Accordingly, the powder material P in the sintered state is crushed and enters a removable state. (c) of FIG. 3 shows a state where a part of the powder material P in the sintered state is removed.

In this way, the powder material P in the sintered state can be removed by repeating the generation and the foaming of the bubbles B.

According to the present embodiment, the following actions and effects are achieved.

In the present embodiment, the ultrasonic wave U is transmitted to the metal lamination-printed article 20 in the state of being immersed in the mixed solvent M. Accordingly, for example, even in a case where there is a narrow portion in the metal lamination-printed article 20, the mixed solvent M flows into the e narrow portion. Therefore, the powder material P remaining in the narrow portion can be removed by the mixed solvent M that has flowed in.

In addition, in the present embodiment, cavitation occurs in the mixed solvent M by the ultrasonic wave U. The flow of the high-pressure and high-speed of the mixed solvent M that occurs when the bubbles generated in the mixed solvent M are foamed, collides with the powder material P in the sintered state, so that the powder material P in the sintered state can be crushed. Accordingly, the powder material P in the sintered state can be removed.

In this way, in the present embodiment, the unnecessary powder can be preferably removed from the metal lamination-printed article 20.

In addition, in the occurrence frequency of cavitation, ease (a height of vapor pressure) of the evaporation of the solvent is predominant and significantly affects. In the present embodiment, a plurality of organic solvents include the first organic solvent having high vapor pressure. Accordingly, the occurrence frequency of cavitation can be improved. Therefore, cavitation can easily occur in the mixed solvent M, so that the powder material P in the sintered state can be more preferably removed.

In addition, in the intensity of cavitation, acoustic impedance (a sound speed×a density) of the solvent is predominant and significantly affects. In the present embodiment, the plurality of organic solvents include the second organic solvent having high acoustic impedance. Accordingly, the intensity of cavitation can be improved. Therefore, cavitation can easily occur in the mixed solvent M, so that the powder material P in the sintered state can be more preferably removed.

In addition, the intensity of cavitation increases in a case where the viscosity of the solvent is small. In the present embodiment, the plurality of organic solvents include the third organic solvent having low viscosity. Accordingly, the intensity of cavitation can be improved. Therefore, cavitation can easily occur in the mixed solvent M, so that the powder material P in the sintered state can be more preferably removed.

In this way, in the present embodiment, by mixing the plurality of organic solvents, the occurrence frequency and the occurrence intensity of cavitation can be improved from a perspective of a physical property of vapor pressure and acoustic impedance. Therefore, the powder material P in the sintered state can be more preferably removed.

In particular, in the present embodiment, the powder material P in the sintered state remaining in a narrow and bottom-shaped internal flow path (for example, the hole 21 of the present embodiment) can be preferably removed. In addition, the present embodiment is particularly effective when a three-dimensional printed article is manufactured from a metal (for example, copper or a copper alloy) likely to generate the powder material P in the sintered state, having a low melting point, and having a low laser absorption rate.

In addition, in a case where the metal lamination-printed article 20 is immersed in water, there is a possibility that the metal lamination-printed article 20 is corroded during cleaning. On the other hand, in the present embodiment, the metal lamination-printed article 20 is immersed in the organic solvent. Accordingly, in a case where an organic solvent that does not corrode the metal is used, corrosion of the metal lamination-printed article 20 during the cleaning can be suppressed.

In addition, in the present embodiment, the metal lamination-printed article 20 is dry-vibrated before ultrasonic wave U cleaning is performed. Accordingly, after an immersion path of the mixed solvent M is secured by the dry vibration, cavitation can efficiently occur in the mixed solvent M having high vapor pressure and high acoustic impedance. Therefore, the powder material P in the sintered state can be preferably removed.

The present disclosure is not limited to each of the above-described embodiments, and can be appropriately modified within a scope that does not depart from the gist of the present disclosure.

For example, the ultrasonic wave generating device 13 may transmit a plurality of ultrasonic waves having different frequencies. For example, in a case where a higher frequency is an integer multiple of a lower frequency, larger amplitude can be generated. Therefore, the powder material P in the more sintered state can be more preferably removed.

In addition, in a case where the higher frequency is not an integer multiple of the lower frequency, an unevenness in amplitude in the mixed solvent M can be suppressed.

Therefore, the unnecessary powder can be preferably removed from the metal lamination-printed article 20.

In addition, for example, the ultrasonic wave generating device 13 may change a frequency of an ultrasonic wave to be transmitted at a predetermined cycle. By using the ultrasonic wave generating device having a sweep function of changing a frequency of an ultrasonic wave to be irradiated at a constant cycle, a generation of a standing wave can be suppressed, in which a position of a peak and a trough of the amplitude is constant. Therefore, a position where cavitation occurs can be changed. Accordingly, a cleaning unevenness can be suppressed.

In addition, the cleaning device 10 may include a vibrating unit (not shown) that vibrates the metal lamination-printed article 20 housed in the inner container 12 in the up-down direction. As a result, by moving the metal lamination-printed article 20 in the up-down direction, a portion where the ultrasonic wave reaches a position with high amplitude and a portion where the ultrasonic wave reaches a position with low amplitude can be changed. Therefore, the cleaning unevenness of the metal lamination-printed article 20 can be suppressed.

In addition, the cleaning device 10 may include a pressure-reducing unit (not shown) that alternately repeats pressure reduction and atmospheric opening inside the inner container 12.

By alternately repeating the pressure reduction and the atmospheric opening inside the inner container 12, the mixed solvent M in the inner container 12 moves. Accordingly, for example, the mixed solvent M is likely to flow into the narrow portion of the metal lamination-printed article 20. The mixed solvent M that has flowed in pushes the powder material out from the narrow portion. Therefore, the powder material can be preferably removed.

In addition, the mixed solvent M flows into the narrow portion, so that cavitation can be easily generated in the narrow portion. Therefore, the powder material P in the sintered state can be more preferably removed.

In addition, when excessive pressure reduction is performed inside the inner container 12, foam frequency of cavitation is significantly reduced. This is considered that, due to an influence of the pressure reduction, the generated gas leaks to an outside of the liquid before the foaming. Therefore, a pressure reduction value may be determined in consideration of both perspectives of the cavitation intensity and an infiltration degree of the mixed solvent M in accordance with a powder removal target.

In addition, in the above-described embodiment, an example has been described, in which the mixed solvent is used, where the three types of the organic solvents of the first organic solvent, the second organic solvent, and the third organic solvent are mixed. However, the mixed solvent may include the first organic solvent and the second organic solvent, and the number of organic solvents to be mixed is not limited to three. The number of organic solvents to be mixed may be, for example, only two types of the first organic solvent and the second organic solvent. An organic solvent other than the first organic solvent, the second organic solvent, and the third organic solvent may be mixed.

For example, the cleaning device and the cleaning method described in the above-described embodiment are understood as follows.

According to a first aspect of the present disclosure, there is provided a cleaning device (10) that cleans a metal lamination-printed article (20) printed by laminating a layer that is a layer in which a metal powder material is laid out and a part of the layer is irradiated with laser light to be fused or sintered, the cleaning device including: a housing unit (12) that is filled with a mixed solvent (M) inside, which is a liquid in which a plurality of organic solvents are mixed and houses the metal lamination-printed article in a state of being immersed in the mixed solvent; and an ultrasonic wave transmitting unit (13) that transmits an ultrasonic wave (U) to the metal lamination-printed article housed in the housing unit, in which the plurality of organic solvents include a first organic solvent having higher vapor pressure than vapor pressure of other organic solvents and a second organic solvent having higher acoustic impedance than acoustic impedance of the other organic solvent.

In the above-described configuration, the ultrasonic waves are transmitted to the metal lamination-printed article in the state of being immersed in the mixed solvent. Accordingly, for example, even in a case where there is the narrow portion in the metal lamination-printed article, the mixed solvent flows into the narrow portion. Therefore, the powder material remaining in the narrow portion can be removed by the mixed solvent that has flowed in.

In addition, in the above-described configuration, cavitation occurs in the mixed solvent by the ultrasonic wave. The flow of the high-pressure and high-speed of the mixed solvent that occurs when the bubbles generated in the mixed solvent are foamed, collides with the powder material in the sintered state, so that the powder material in the sintered state can be crushed. Accordingly, the powder material in the sintered state can be removed.

In this way, in the above-described configuration, the unnecessary powder can be preferably removed from the metal lamination-printed article.

In addition, in the occurrence frequency of cavitation, ease (a height of vapor pressure) of the evaporation of the solvent is predominant and significantly affects. In the above-described configuration, the plurality of organic solvents include the first organic solvent having high vapor pressure. Accordingly, the occurrence frequency of cavitation can be improved. Therefore, cavitation can easily occur in the mixed solvent, so that the powder material in the sintered state can be more preferably removed.

As the first organic solvent, for example, an organic solvent is preferable, which has vapor pressure equal to or higher than 2.5 kPa at room temperature. For example, the first organic solvent may be acetone.

In addition, in the intensity of cavitation, acoustic impedance (a sound speed×a density) of the solvent is predominant and significantly affects. In the above-described configuration, the plurality of organic solvents include the second organic solvent having high acoustic impedance. Accordingly, the intensity of cavitation can be improved. Therefore, cavitation can easily occur in the mixed solvent, so that the powder material in the sintered state can be more preferably removed.

The second organic solvent is, for example, preferably an organic solvent having acoustic impedance equal to or higher than 700 kPa·s/m³ at room temperature. For example, the second organic solvent may be methyl ethyl ketone, isopropyl alcohol, or ethanol.

In this way, in the above-described configuration, mixing the plurality of organic solvents, the occurrence frequency and the occurrence intensity of cavitation can be improved from a perspective of a physical property of vapor pressure and acoustic impedance. Therefore, the powder material in the sintered state can be more preferably removed.

In addition, in a case where the metal lamination-printed article is immersed in water, there is a possibility that the metal lamination-printed article is corroded during cleaning. On the other hand, in the above-described configuration, the metal lamination-printed article is immersed in the organic solvent. Accordingly, in a case where an organic solvent that does not corrode the metal is used, corrosion of the metal lamination-printed article during the cleaning can be suppressed.

In addition, according to a second aspect of the present disclosure, there is provided the cleaning device in the first aspect, in which the plurality of organic solvents include a third organic solvent having lower viscosity than viscosity of the other organic solvent.

The intensity of cavitation increases in a case where the viscosity of the solvent is small. In the above-described configuration, the plurality of organic solvents include the third organic solvent having low viscosity. Accordingly, the intensity of cavitation can be improved. Therefore, cavitation can easily occur in the mixed solvent, so that the powder material in the sintered state can be more preferably removed.

As the third organic solvent, for example, an organic solvent having viscosity equal to or lower than 1.0 mPas at room temperature is preferable. For example, as the third organic solvent, n-hexane, n-pentane, or an ether may be used.

In addition, according to a third aspect of the present disclosure, there is provided the cleaning device in the first aspect or the second aspect, in which the ultrasonic wave transmitting unit transmits a plurality of ultrasonic waves having different frequencies.

In the above-described configuration, the ultrasonic wave transmitting unit transmits the plurality of ultrasonic waves having As a different frequencies. result, for example, in a case where a higher frequency is an integer multiple of a lower frequency, larger amplitude can be generated. In addition, in a case where the higher frequency is not an integer multiple of the lower frequency, an unevenness in amplitude in the mixed solvent can be suppressed. Therefore, the unnecessary powder can be preferably removed from the metal lamination-printed article.

In addition, according to a fourth aspect of the present disclosure, there is provided the cleaning device in any of the first aspect to the third aspect, in which the ultrasonic wave transmitting unit changes a frequency of the ultrasonic wave to be transmitted at a predetermined cycle.

In the above-described configuration, the ultrasonic wave transmitting unit changes the frequency of the ultrasonic wave to be transmitted at a predetermined cycle. Accordingly, the generation of the standing wave can be suppressed. Therefore, a position where cavitation occurs can be changed. Therefore, the cleaning unevenness of the metal lamination-printed article can be suppressed.

In addition, according to a fifth aspect of the present disclosure, there is provided the cleaning device in any of the first aspect to the fourth aspect, the cleaning device includes a vibrating unit that vibrates the metal lamination-printed article housed in the housing unit in an up-down direction.

In the above-described configuration, the vibrating unit that vibrates the metal lamination-printed article housed in the housing unit in the up-down direction is provided. As a result, by moving the metal lamination-printed article in the up-down direction, a portion where the ultrasonic wave reaches a position with high amplitude and a portion where the ultrasonic wave reaches a position with low amplitude can be changed. Therefore, the cleaning unevenness of the metal lamination-printed article can be suppressed.

In addition, according to a sixth aspect of the present disclosure, there is provided the cleaning device in any of the first aspect to the fifth aspect, the cleaning device includes a pressure-reducing unit that alternately repeats pressure reduction and atmospheric opening inside the housing unit.

In the above-described configuration, the pressure-reducing unit that performs the pressure reduction and the atmospheric opening inside the housing unit is provided. By alternately repeating the pressure reduction and the atmospheric opening inside the housing unit, the mixed solvent in the housing unit moves. Accordingly, for example, the mixed solvent is likely to flow into the narrow portion. The mixed solvent that has flowed in pushes the powder material out from the narrow portion. Therefore, the powder material can be preferably removed.

In addition, the mixed solvent flows into the narrow portion, so that cavitation can be easily generated in the narrow portion. Therefore, the powder material in the sintered state can be more preferably removed.

According to the first aspect of the present disclosure, there is provided a cleaning method for cleaning a metal lamination-printed article (20) printed by laminating a layer that is a layer in which a metal powder material is laid out and a part of the layer is irradiated with laser light to be fused or sintered, the cleaning method including: a housing step of housing the metal lamination-printed article in a state of being immersed in a mixed solvent in a housing unit (12) filled with the mixed solvent (M) inside, which is a liquid in which a plurality of organic solvents are mixed; and an ultrasonic wave transmitting step of transmitting an ultrasonic wave from an ultrasonic wave transmitting unit (13) to the metal lamination-printed article housed in the housing unit, in which the plurality of organic solvents include a first organic solvent having higher vapor pressure than vapor pressure of other organic solvents and a second organic solvent having higher acoustic impedance than acoustic impedance of the other organic solvent.

### REFERENCE SIGNS LIST

10: cleaning device
11: outer container
11a: outer container main body portion
11b: outer container bottom surface portion
12: inner container
12a: inner container main body portion
12b: inner container bottom surface portion
12c: lid portion
13: ultrasonic wave generating device
14: porous plate
20: metal lamination-printed article
21: hole
A: arrow
B: bubble
M: mixed solvent
P: powder material
U: ultrasonic wave
W: water

1. A cleaning device that cleans a metal lamination-printed article printed by laminating a layer that is a layer in which a metal powder material is laid out and a part of the layer is irradiated with laser light to be fused or sintered, the cleaning device comprising:
a housing unit that is filled with a mixed solvent inside, which is a liquid in which a plurality of organic solvents are mixed and houses the metal lamination-printed article in a state of being immersed in the mixed solvent; and
an ultrasonic wave transmitting unit that transmits an ultrasonic wave to the metal lamination-printed article housed in the housing unit,
wherein the plurality of organic solvents include a first organic solvent having higher vapor pressure than vapor pressure of other organic solvents and a second organic solvent having higher acoustic impedance than acoustic impedance of the other organic solvent, and
wherein a plurality of bottom-shaped holes are formed in the metal lamination-printed article.

2. The cleaning device according to claim 1,
wherein the plurality of organic solvents include a third organic solvent having lower viscosity than viscosity of the other organic solvent.

3. The cleaning device according to claim 1,
wherein the ultrasonic wave transmitting unit transmits a plurality of ultrasonic waves having different frequencies.

4. The cleaning device according to claim 1,
wherein the ultrasonic wave transmitting unit changes a frequency of the ultrasonic wave to be transmitted at a predetermined cycle.

5. The cleaning device according to claim 1, further comprising:
a vibrating unit that vibrates the metal lamination-printed article housed in the housing unit in an up-down direction.

6. The cleaning device according to claim 1, further comprising:
a pressure-reducing unit that alternately repeats pressure reduction and atmospheric opening inside the housing unit.

7. A cleaning method for cleaning a metal lamination-printed article printed by laminating a layer that is a layer in which a metal powder material is laid out and a part of the layer is irradiated with laser light to be fused or sintered, the cleaning method comprising:
a housing step of housing the metal lamination-printed article in a state of being immersed in a mixed solvent in a housing unit filled with the mixed solvent inside, which is a liquid in which a plurality of organic solvents are mixed; and
an ultrasonic wave transmitting step of transmitting an ultrasonic wave from an ultrasonic wave transmitting unit to the metal lamination-printed article housed in the housing unit,
wherein the plurality of organic solvents include a first organic solvent having higher vapor pressure than vapor pressure of other organic solvents and a second organic solvent having higher acoustic impedance than acoustic impedance of the other organic solvent, and
wherein a plurality of bottom-shaped holes are formed in the metal lamination-printed article.
